(19) United States
(12) Patent Application Publication
(10) Pub. No.: US 2025/0302687 A1
(43) Pub. Date: Oct. 2, 2025

(54) CHAIR

(71) Applicant: TOYOTA JIDOSHA KABUSHIKI KAISHA, Toyota-shi (JP)

(72) Inventor: Tadashi ODASHIMA, Seto-shi (JP)

(73) Assignee: TOYOTA JIDOSHA KABUSHIKI KAISHA, Toyota-shi (JP)

(21) Appl. No.: 19/077,446

(22) Filed: Mar. 12, 2025

(30) Foreign Application Priority Data
Apr. 1, 2024 (JP) 2024-058842

(51) Int. Cl. A61H 1/00; A47C 9/00

(52) U.S. Cl. CPC A61H 1/005; A47C 9/002; A61H 2201/0149; A61H 2201/1215; A61H 2201/1633; A61H 2201/5007; A61H 2203/0431; A61H 2205/088

(57) ABSTRACT

In a chair, a bearing surface inclines the pelvis of a seated user. A rigid pole includes a lower end portion and an upper end portion. An elastic body is disposed on the lower side of the bearing surface and generates restoring force in all radial directions of the bearing surface depending on an inclination angle of the bearing surface. An adjustment mechanism adjusts the magnitude of the restoring force of the elastic body. A rotation table is installed on the upper side of a base and rotates around a height-directional axis due to dynamic power. Support poles are constituted by a plurality of support poles installed on the upper side of the rotation table, support the bearing surface at upper end portions of the support poles when the bearing surface is inclined, and have different height-directional lengths. A motor generates the dynamic power.

### CROSS-REFERENCE TO RELATED APPLICATION

This application claims priority to Japanese Patent Application No. 2024-058842 filed on Apr. 1, 2024, incorporated herein by reference in its entirety.

### BACKGROUND

### 1. Technical Field

The present disclosure relates to a chair.

### 2. Description of Related Art

Japanese Unexamined Patent Application Publication No. 2003-235917 (JP 2003-235917 A) discloses a chair that induces an exercise of the trunk of a user by changing a bearing surface in an entire circumference direction in a state where the bearing surface is fixed so as to be inclined in a predetermined direction. Further, JP 2003-235917 A discloses a chair that generates the inclination of the bearing surface in accordance with the slope of the user, by connecting a base and the bearing surface by a free joint.

### SUMMARY

However, in the chair according to JP 2003-235917 A, the inclination of the bearing surface is fixed, and therefore, it is expected that only muscles for making a particular posture of the user are tensed. Further, in the chair, the inclination of the bearing surface is decided by the posture of the user, and therefore, it is expected that the activity degree of muscles with respect to the slope is limited. Therefore, the chair according to JP 2003-235917 A has a problem in that it is not possible to activate a plurality of antigravity muscles necessary for maintaining the posture of the user while the user is unconscious of the exercise.

The present disclosure provides a chair that makes it possible to activate a plurality of antigravity muscles necessary for maintaining the posture of the user while the user is unconscious of the exercise.

An aspect of the present disclosure relates to a chair including a base, a bearing surface, a rigid pole, an elastic body, an adjustment mechanism, a rotation table, a plurality of support poles, and a motor. The bearing surface is configured to incline the pelvis of a seated user. The rigid pole includes a lower end portion that is fixed to the base and an upper end portion that is fixed to the bearing surface such that the bearing surface is able to be inclined in all radial directions. The elastic body is disposed on the lower side of the bearing surface and is configured to generate restoring force in all radial directions of the bearing surface depending on the inclination angle of the bearing surface. The adjustment mechanism is disposed between the elastic body and the base. Moreover, the adjustment mechanism is configured to adjust the magnitude of the restoring force of the elastic body. The rotation table is installed on the upper side of the base and is configured to rotate around a height-directional axis due to dynamic power. The plurality of support poles is installed on the upper side of the rotation table, is configured to support the bearing surface at upper end portions of the support poles when the bearing surface is inclined, and has different height-directional lengths. The motor is configured to generate the dynamic power.

In the chair in the above aspect, the elastic body may be a spring made of metal, or may be a tubular member composed of an elastomer.

In the chair in the above aspect, the elastic body may be disposed between the bearing surface and the adjustment mechanism, so as to generate the restoring force in all radial directions of the bearing surface depending on the inclination angle of the bearing surface, such that the central axis of the elastic body coincides with the central axis of the rigid pole.

In the chair in the above aspect, the elastic body or a plurality of the elastic bodies may be disposed in the circumferential direction of the rigid pole between the bearing surface and the adjustment mechanism, so as to generate the restoring force in all radial directions of the bearing surface depending on the inclination angle of the bearing surface.

In the chair in the above aspect, the adjustment mechanism may be configured to adjust the magnitude of the restoring force of the elastic body, by moving a surface of the adjustment mechanism along the rigid pole, the surface of the adjustment mechanism abutting on the elastic body.

In the chair in the above aspect, the rigid pole may include a D-cut portion and a male thread portion disposed on the lower side of the D-cut portion. The adjustment mechanism may include a support portion including a through-hole in which the D-cut portion is provided and a nut portion provided around the male thread portion by screwing. The elastic body may be disposed between the bearing surface and the support portion. The support portion may be attached to the rigid pole in a state where the D-cut portion is provided in the through-hole and where the support portion is able to move along the D-cut portion. The adjustment mechanism may adjust the magnitude of the restoring force of the elastic body, by adjusting the screwing amount the nut portion with respect to the male thread portion and moving the support portion along the D-cut portion.

The chair in the above aspect may include a controller configured to increase or decrease the rotation speed of the motor.

With the chair in the above aspect, it is possible to induce an effective trunk exercise of a user that is seated on the chair, and to reduce the load while causing the user to maintain the posture.

The chair in the present disclosure makes it possible to activate a plurality of antigravity muscles necessary for maintaining the posture of the user while the user is unconscious of the exercise.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a perspective view showing an exemplary configuration of a chair according to a first embodiment of the present disclosure;

FIG. 2 is a side view showing an exemplary configuration of a support mechanism of the chair according to the first embodiment;

FIG. 3 is a side view showing an exemplary configuration of a coupling pole mechanism of the support mechanism of the chair according to the first embodiment;

FIG. 4 is a side view showing an exemplary configuration of support poles of the chair according to the first embodiment;

FIG. 5 is a diagram showing an exemplary configuration of a dynamic power transmission mechanism of the chair according to the first embodiment;

FIG. 6 is a side view showing an exemplary configuration of a coupling support mechanism of a support mechanism of a chair according to a second embodiment of the present disclosure;

FIG. 7 is a sectional view showing the exemplary configuration of the coupling support mechanism of the support mechanism of the chair according to the second embodiment;

FIG. 8 is a side view showing an exemplary configuration of a coupling pole mechanism of a support mechanism of a chair according to a third embodiment of the present disclosure;

FIG. 9 is a top view showing an exemplary configuration of the coupling pole mechanism of the support mechanism of the chair according to the third embodiment;

FIG. 10 is a plan view showing an exemplary disposition of springs of the chair according to the third embodiment; and

FIG. 11 is a plan view showing an exemplary disposition of springs of the chair according to the third embodiment.

### DETAILED DESCRIPTION OF EMBODIMENTS

Specific embodiments to which the present disclosure is applied will be described below in detail with reference to the drawings. In the drawings, identical elements are denoted by identical reference characters, and repetitive descriptions are omitted as necessary, for clear descriptions.

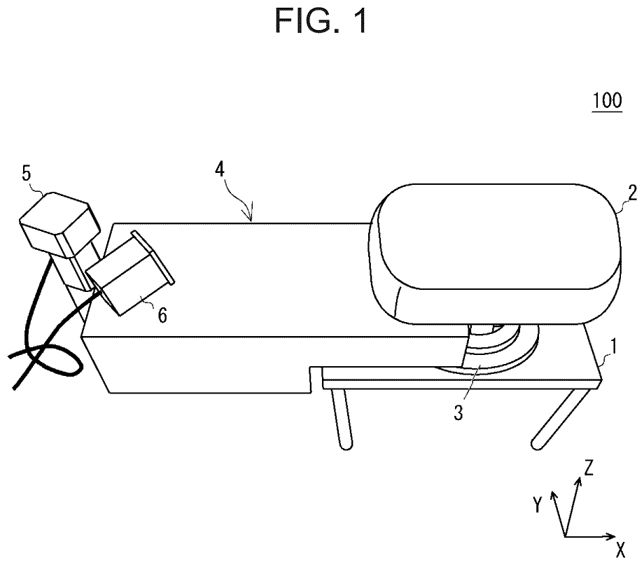

First, the configuration of a chair 100 according to the first embodiment will be described with use of FIG. 1 to FIG. 5. FIG. 1 is a perspective view showing an exemplary configuration of the chair according to the first embodiment. As shown in FIG. 1, the chair 100 includes a base 1, a bearing surface 2, a support mechanism 3, a dynamic power transmission mechanism 4, a motor 5, and a controller 6.

The base 1 is a foundation that is a basic member on which constituent elements of the chair 100 are mounted. The bearing surface 2 is a bearing surface on which a user is seated. The bearing surface 2 inclines the pelvis of the seated user.

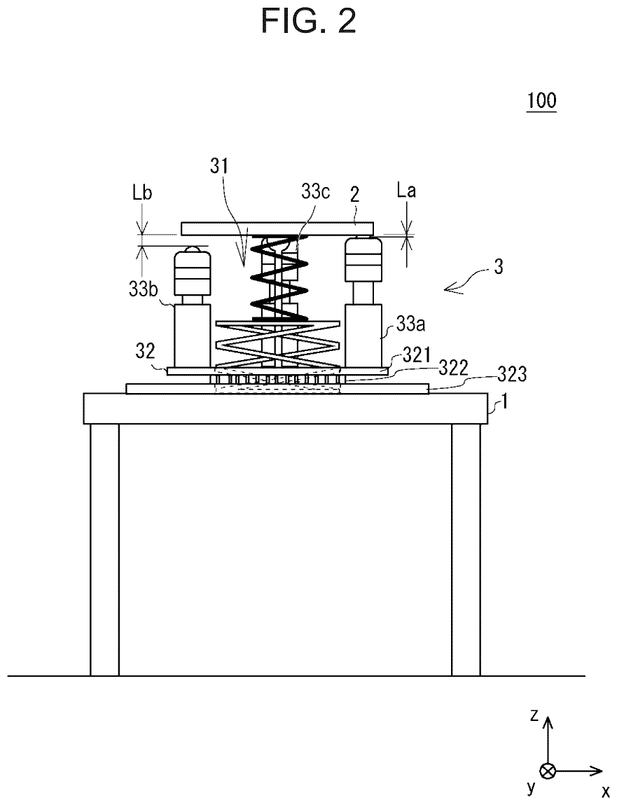

The support mechanism 3 is a mechanism that is interposed between the base 1 and the bearing surface 2 and that supports the bearing surface 2. When the user is not seated on the bearing surface 2, the support mechanism 3 keeps the bearing surface 2 in a reference state. For example, the reference state is a state where the bearing surface 2 is parallel to a horizontal plane (xy-plane). When the user is seated on the bearing surface 2, the support mechanism 3 allows the inclination of the bearing surface 2 from the reference state, and further temporally changes a direction in which the inclination is allowed, around a height-directional (z-axis-directional) axis. Specifically, the support mechanism 3 includes a configuration shown in FIG. 2.

FIG. 2 is a side view showing an exemplary configuration of the support mechanism 3 of the chair 100 according to the first embodiment. As shown in FIG. 2, the support mechanism 3 includes a coupling pole mechanism 31, a rotation table 32, and a plurality of support poles, i.e. a support pole 33a, a support pole 33b and a support pole 33c. 10

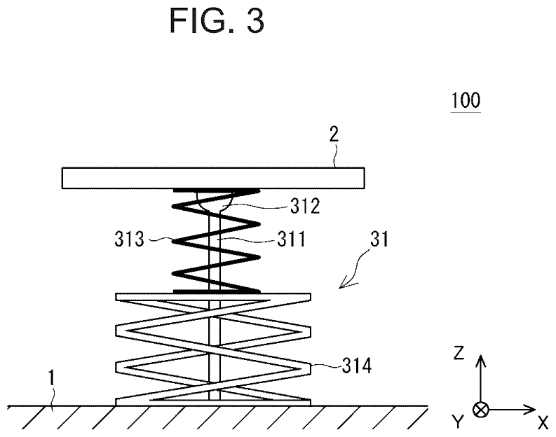

The coupling pole mechanism 31 is a pole mechanism that couples the base 1 and the bearing surface 2. Specifically, the coupling pole mechanism 31 includes a configuration shown in FIG. 3. FIG. 3 is a side view showing an exemplary configuration of the coupling pole mechanism 31 of the support mechanism 3 of the chair 100 according to the first embodiment. As shown in FIG. 3, the coupling pole mechanism 31 includes a rigid pole 311, a ball joint 312, a spring (elastic body) 313, and a jack (adjustment mechanism) 314.

The rigid pole 311 is a rigid member that is hard to elastically deform and that is composed of steel or the like. The rigid pole 311 includes a lower end portion that is fixed to the base 1. Further, the rigid pole 311 includes an upper end portion that is fixed to the bearing surface 2 such that the bearing surface 2 can be inclined in all radial directions. It is preferable that the central axis of the rigid pole 311 coincides with the center or gravity center of the bearing surface 2.

The upper end portion of the rigid pole 311 is fixed to the bearing surface 2 by the ball joint 312. Thereby, the freedom degree of the inclination angle of the bearing surface 2 is given while the translation of the bearing surface 2 (that is, the movement of the bearing surface 2 in the xy-direction) is avoided. The ball joint 312 is installed at a place that is very close to an upper surface of the bearing surface 2 (that is, to the position of the pelvis of the user), and thereby, it is possible to minimize the movement amount in a translation direction when the bearing surface 2 is inclined. It is preferable that the rotation center of the ball joint 312 is disposed in the interior of the bearing surface 2, for example, by boring the bearing surface 2 from the bottom portion side.

The spring 313 is disposed on the lower side of the bearing surface 2. The spring 313 is disposed between the bearing surface 2 and the jack 314, so as to generate restoring force in all radial directions of the bearing surface 2 depending on the inclination angle of the bearing surface 2. The restoring force is the force that acts for the restoration of the spring 313 after the elastic deformation of the spring 313. A reference is provided for a predetermined amount of restoring force that is generated from the spring 313, and the spring 313 is disposed in accordance with the reference. Specifically, the spring 313 is disposed such that the variation among inclination directions of the bearing surface 2 in the amount (value) of the restoring force that is generated from the spring 313 is within a certain range. In other words, the spring 313 is disposed such that the amount of the restoring force that is generated from the spring 313 is roughly the same regardless of the direction of the inclination of the bearing surface 2. In the first embodiment, the spring 313 is disposed between the bearing surface 2 and the jack 314, such that the rigid pole 311 is disposed on the inside of the spring 313 and the central axis of the spring 313 coincides with the central axis of the rigid pole 311. It is preferable that the winding number of the spring 313 is set such that the variation among inclination directions of the bearing surface 2 in the amount of the restoring force that is generated from the spring 313 is within a certain range. Further, for the spring 313, a reaction force generation mechanism such as a shock absorber may be used.

The jack 314 is disposed between the spring 313 and the base 1. The rigid pole 311 is inserted into the interior of the jack 314. The jack 314 adjusts the magnitude of the restoring force of the spring 313. The jack 314 can increase or decrease an initial value of the spring 313, by moving a surface of the jack 314 that abuts on the spring 313, in the height direction. The jack 314 can adjust the magnitude of the restoring force against the inclination of the bearing surface 2, by the pressure that is given to the spring 313.

The bearing surface 2 is allowed to be inclined only around a pitch axis (y-axis) and a roll axis (x-axis). The spring 313 and the bearing surface 2 are joined and the spring 313 and the jack 314 are joined, such that the bearing surface 2 does not rotate around a yaw axis (z-axis).

In the chair 100, another elastic body may be used instead of the spring 313, as long as the isotropy of the restoring force against the inclination of the bearing surface 2 is roughly secured. For example, a tubular elastomer may be used instead of the spring 313 made of metal.

Further, in the chair 100, the length of the rigid pole 311 may be capable of being adjusted, in order that the height of the bearing surface 2 can be adjusted in conformity to the body shape of the user. In that case, the chair 100 needs to include a mechanism that can adjust the length of the rigid pole 311, independently from the jack 314 as an adjustment mechanism that adjusts the restoring force of the spring 313, and needs to include such a configuration that the restoring force can be adjusted over a whole range in which the length of the rigid pole 311 is adjusted.

The description of FIG. 2 will be resumed. The rotation table 32 includes a rotation portion 321, a gear portion 322, and a rotation foundation portion 323. The rotation portion 321 is a discoid member, for example, and is installed on the rotation foundation portion 323 so as to rotate around the height-directional (z-axis-directional) axis with the rotation of the gear portion 322. The gear portion 322 is a pulley that interlock with the rotation portion 321, for example, and has an outer circumferential surface provided with teeth to which a belt or the like for receiving dynamic power from the dynamic power transmission mechanism 4 is attached. Further, the rotation table 32 includes a perforated portion (not illustrated) through which the coupling pole mechanism 31 passes.

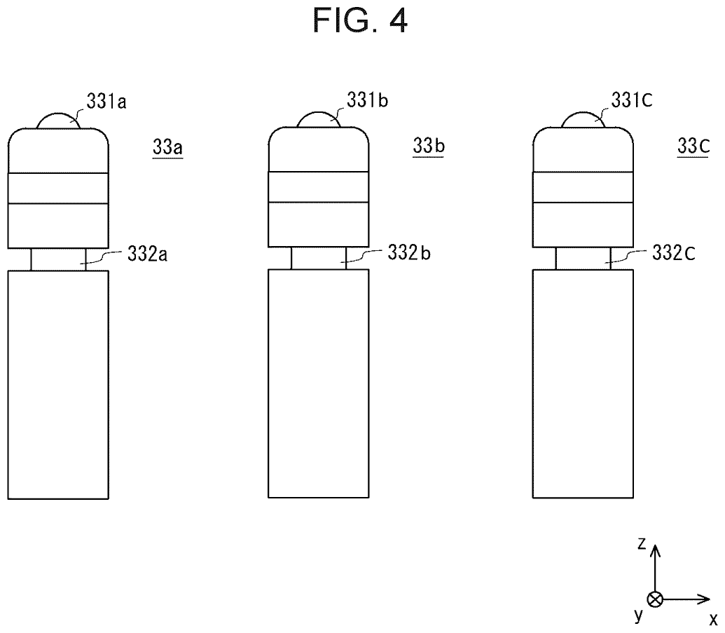

The support pole 33a, the support pole 33b and the support pole 33c are columnar members that are provided on a surface on the upper side (z-axis positive-directional side) of the rotation portion 321 of the rotation table 32. The support pole 33a, the support pole 33b and the support pole 33c support the bearing surface 2 at each of an upper end portion of the support pole 33a, the support pole 33b and the support pole 33c, when the user is seated on the bearing surface 2 and the bearing surface 2 is inclined. The plurality of support poles, i.e. the support pole 33a, the support pole 33b and the support pole 33c are provided along a circle at regular intervals on the surface on the upper side of the rotation portion 321, but the place where each of the support poles, i.e. a support pole 33a, a support pole 33b and a support pole 33c are provided can be set. Specifically, the support pole 33a, the support pole 33b and the support pole 33c include a configuration shown in FIG. 4.

FIG. 4 is a side view showing an exemplary configuration of support poles 33a, 33b, and 33c of the chair 100 according to the first embodiment. The support pole 33a includes an upper end portion 331a and a length adjustment portion 332a. The upper end portion 331a is a ball-shaped member, for example, and supports the bearing surface 2 when the bearing surface 2 is inclined. By employing a ball-shaped member as the upper end portion 331a, it is possible to rotate the rotation table 32 with small resistance even when the load of the user on the bearing surface 2 is focused in the inclination direction. The length adjustment portion 332a is a screw type, for example, and adjusts the length of the support pole 33a.

A support pole 33b includes the same configuration as the support pole 33a. That is, the support pole 33b includes an upper end portion 331b and a length adjustment portion 332b. Further, a support pole 33c also includes the same configuration as the support pole 33a. That is, the support pole 33c includes an upper end portion 331c and a length adjustment portion 332c.

The description of FIG. 2 will be resumed. Each height-directional length of the plurality of support poles, i.e. the support pole 33a, the support pole 33b and the support pole 33c are decided such that the bearing surface 2 is inclined from the reference state by a predetermined angle when the user is seated. For the generation of the inclination, at least one of the plurality of support poles, i.e. the support pole 33a, the support pole 33b and the support pole 33c is adjusted so as to be shorter than the other support poles in the support pole 33a, the support pole 33b and the support pole 33c in height-directional length. For example, the support pole 33b is adjusted so as to be shorter than the support pole 33a in height-directional length. In other words, the length of the support pole 33b is adjusted such that a distance Lb between the upper end portion 331b of the support pole 33b and the lower side of the bearing surface 2 is larger than a distance La between the upper end portion 331a of the support pole 33a and the lower side of the bearing surface 2. Further, the support pole 33b is adjusted so as to be shorter than the support pole 33c in height-directional length. The direction and angle of the allowed inclination of the bearing surface 2 are decided depending on the respective lengths of the support pole 33a, the support pole 33b, and the support pole 33c. Furthermore, it is preferable that the upper end portion 331a of the support pole 33a and the upper end portion 331c of the support pole 33c contact with the lower side of the bearing surface 2.

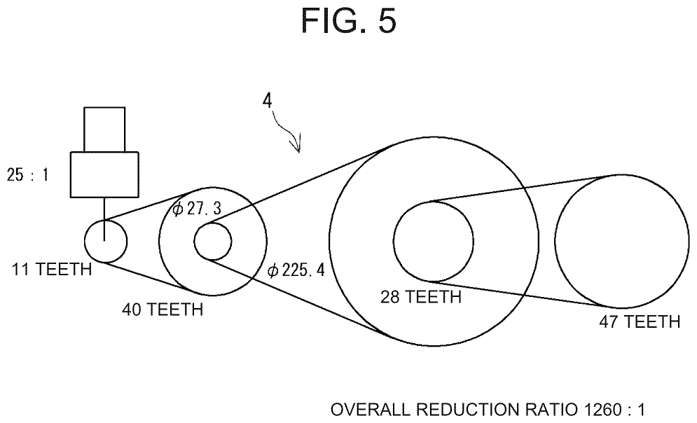

The description of FIG. 1 will be resumed. The dynamic power transmission mechanism 4 is constituted by a belt and a pulley, or by a chain and a sprocket, for example, and transmits the dynamic power generated by the motor 5, to the rotation table 32 of the support mechanism 3. Specifically, the dynamic power transmission mechanism 4 includes a configuration shown in FIG. 5.

FIG. 5 is a diagram showing an exemplary configuration of the dynamic power transmission mechanism 4 of the chair 100 according to the first embodiment. As shown in FIG. 5, the dynamic power transmission mechanism 4 includes a configuration in which the motor 5 that rotates at a reduction ratio of 25:1, a 11-tooth pulley that interlocks with the rotation of the motor 5, a 40-tooth pulley, a 28-tooth pulley, and the gear portion 322 of the rotation table 32 that includes 47 teeth are connected by belts. In the dynamic power transmission mechanism 4, a high reduction ratio is necessary for a very slow rotation, and therefore, a very high reduction ratio, that is, an overall reduction ratio of 1260:1 is employed.

The description of FIG. 1 will be resumed. The motor 5 is an electric motor, for example, and generates dynamic power by rotating. The controller 6 controls the rotation of the motor 5. For example, the controller 6 can increase or decrease the rotation speed of the motor 5. The controller 6 may perform switching between the increase and decrease in the rotation speed of the motor 5, at a predetermined interval.

Next, an exemplary action of the chair 100 according to the first embodiment will be described. The user is seated on the bearing surface 2 of the chair 100. On this occasion, the bearing surface 2 is supported by the plurality of support poles, i.e. the support pole 33a, the support pole 33b and the support pole 33c of the support mechanism 3. In the case where at least one of the plurality of support poles, i.e. the support pole 33a, the support pole 33b and the support pole 33c is shorter in length than the other support poles in the support pole 33a, the support pole 33b and the support pole 33c, the inclination of the bearing surface 2 is allowed. The direction and angle of the allowed inclination of the bearing surface 2 are decided depending on the respective lengths of the plurality of support poles, i.e. the support pole 33a, the support pole 33b and the support pole 33c.

Moreover, the user operates the controller 6. The controller 6 controls the rotation of the motor 5 based on the user's operation. The motor 5 generates dynamic power based on the control by the controller 6, and transmits the generated dynamic power to the rotation table 32 of the support mechanism 3 through the dynamic power transmission mechanism 4. The rotation portion 321 of the rotation table 32 rotates around the height-directional axis, based on the transmitted dynamic power, and rotates the plurality of installed support poles, i.e. the support pole 33a, the support pole 33b and the support pole 33c in the same direction. Thereby, the direction in which the bearing surface 2 is allowed to be inclined temporally changes.

As described above, the chair 100 inclines the pelvis of the user in all radial directions of the bearing surface 2. The user activates the erector spinae muscle that is a deep muscle of the trunk, such that the head position (that is, the eye line) is stabilized by the chair 100, and performs an unconscious exercise such that the inclination of the pelvis is cancelled out. Accordingly, the chair 100 can induce the trunk exercise, through the exercise that is an unconscious exercise but is an active exercise, when the user is merely sitting. That is, when the user is seated on the chair 100, it is possible to activate a plurality of antigravity muscles necessary for maintaining the posture of the user while the user is unconscious of the exercise.

Further, for the activation of the erector spinae muscle, which does not originally generate a large displace amount, the inclination angle of the bearing surface 2 may be small, and a small inclination angle restrains an excessive movement of the head. Therefore, in the chair 100, the inclination of the bearing surface 2 is unlikely to hinder seated desk works such as typing with a personal computer or writing, and therefore, the user can use a daily seated work time, as a health time, with no change.

Further, in the above-described concept, the inclination of the pelvis is important, and the user had better not perform the exercise in the translation direction rather. Therefore, in the above configuration, a mechanism that allows only the change in posture angle is demanded. The chair 100 includes a configuration in which the upper end portion of the rigid pole 311 of the coupling pole mechanism 31 is fixed to the bearing surface 2 by the ball joint 312. Therefore, the chair 100 avoids the translation (that is, the movement of the bearing surface 2 in the xy-direction) of the bearing surface 2, and gives the freedom degree of the inclination angle of the bearing surface 2. That is, it is possible to allow only the change in posture angle without the exercise in the translation direction.

Further, when the posture angle is completely freed, the inclination is biased in one direction by the habit of the sitting way of the seated person, so that the bad posture is worsened. Therefore, the bearing surface needs to receive the restoring force corresponding to the inclination. The necessary magnitude of the restoring force is different depending on the body weight of the user and the habit of the posture, and therefore, it is desirable that the restoring force can be easily adjusted and the load of the user can be adjusted while the user maintains the posture. The chair 100 includes a mechanism that adjusts the restoring force with the spring 313 and jack 314 of the coupling pole mechanism 31. Therefore, the chair 100 can reduce the load while causing the user to maintain the posture.

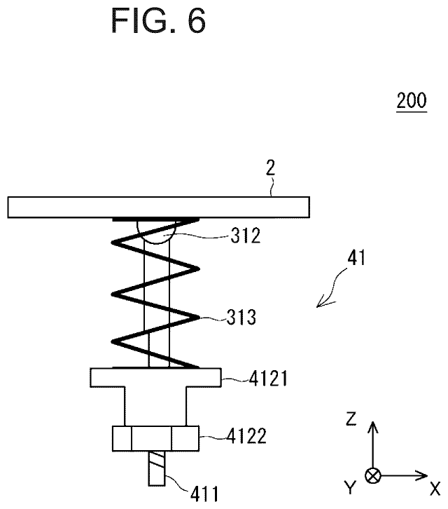

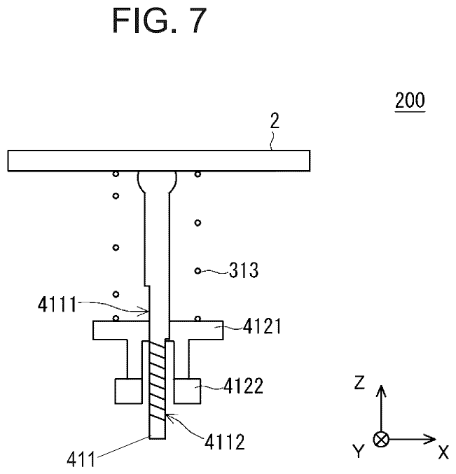

Next, the configuration of a chair 200 according to a second embodiment will be described with use of FIG. 6 and FIG. 7. The chair 200 basically includes the same configuration (the base 1, the bearing surface 2, the support mechanism 3, the dynamic power transmission mechanism 4, the motor 5, and the controller 6) as the chair 100 according to the first embodiment. However, the chair 200 includes an adjustment mechanism that adjusts the magnitude of the restoring force of the spring 313 and that is different from the adjustment mechanism of the chair 100 according to the first embodiment. Specifically, compared to the chair 100, the chair 200 includes a coupling support mechanism 41 in the support mechanism 3, instead of the coupling pole mechanism 31. The configuration of the coupling support mechanism 41 of the support mechanism 3 of the chair 200 is specifically shown in FIG. 6 and FIG. 7.

FIG. 6 is a side view showing an exemplary configuration of the coupling support mechanism 41 of the support mechanism 3 of the chair 200 according to the second embodiment. FIG. 7 is a sectional view showing an exemplary configuration of the coupling support mechanism 41 of the support mechanism 3 of the chair 200 according to the second embodiment.

As shown in FIG. 6 and FIG. 7, compared to the coupling pole mechanism 31 of the chair 100, the coupling support mechanism 41 of the chair 200 includes a rigid pole 411 instead of the rigid pole 311, and includes a support portion 4121 and a nut portion 4122 instead of the jack 314. Further, similarly to the coupling pole mechanism 31 of the chair 100, the coupling support mechanism 41 of the chair 200 includes the ball joint 312 and the spring 313.

The rigid pole 411 includes a D-cut portion 4111 and a male thread portion 4112 disposed on the lower side of the D-cut portion 4111, in addition to the above-described configuration of the rigid pole 311.

The support portion 4121 and the nut portion 4122 constitutes an adjustment mechanism that adjusts the magnitude of the restoring force of the spring 313. The support portion 4121 includes a through-hole into which the D-cut portion 4111 is inserted. The support portion 4121 is attached to the rigid pole 411 in a state where the D-cut portion 4111 is inserted into the through-hole and where the support portion 4121 can move along the D-cut portion 4111. The nut portion 4122 is provided around the male thread portion 4112 by screwing. The nut portion 4122 moves the support portion 4121 along the D-cut portion 4111 by the adjustment of the screwing amount with respect to the male thread portion 4112, and thereby, adjusts the magnitude of the restoring force of the spring 313.

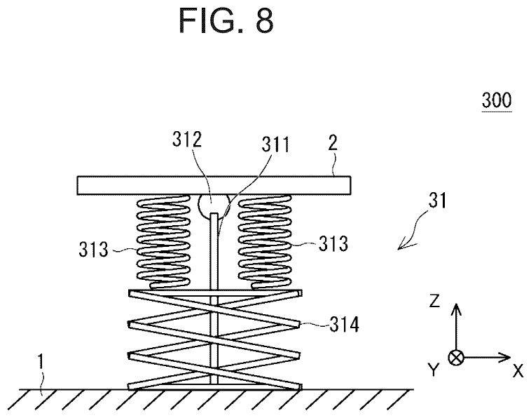

Next, the configuration of a chair 300 according to a third embodiment will be described with use of FIG. 8. The chair 300 includes the same configuration (the base 1, the bearing surface 2, the support mechanism 3, the dynamic power transmission mechanism 4, the motor 5, and the controller 6) as the chair 100 according to the first embodiment, but is different in the configuration of the coupling pole mechanism 31 of the support mechanism 3.

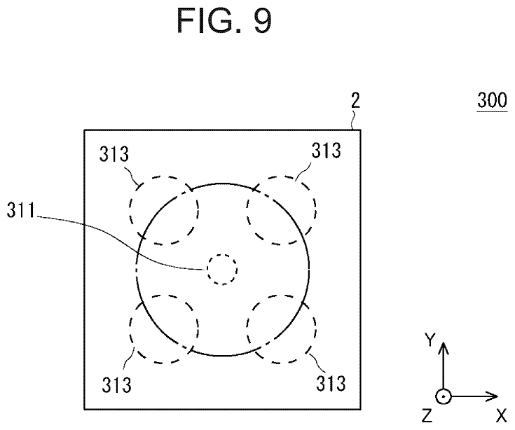

FIG. 8 is a side view showing an exemplary configuration of the coupling pole mechanism 31 of the support mechanism 3 of the chair 300 according to the third embodiment. In the chair 100 according to the first embodiment, the single spring 313 is disposed, but in the chair 300 according to the third embodiment, a plurality of springs 313 is disposed as shown in FIG. 8. For a predetermined amount of restoring force that is generated from the plurality of springs 313, a reference is provided, and each of the plurality of springs 313 is disposed in accordance with the reference. Specifically, each of the plurality of springs 313 is disposed such that the variation among inclination directions of the bearing surface 2 in the total amount (total value) of restoring forces that are generated from the plurality of springs 313 is within a certain range. In other words, each of the plurality of springs 313 is disposed such that the total amount of restoring forces that are generated from the plurality of springs 313 is roughly the same regardless of the direction of the inclination of the bearing surface 2. For example, each of the plurality of springs 313 is disposed as shown in FIG. 9.

FIG. 9 is a top view showing an exemplary configuration of the coupling pole mechanism 31 of the support mechanism 3 of the chair 300 according to the third embodiment. As shown in FIG. 9, the plurality of springs 313 is disposed along a circle (shown by a dash-dot line in the figure) in the circumferential direction of the rigid pole 311. The number of springs 313 that are disposed is not limited to four in FIG. 9, and may be a multiple number other than four. It is preferable that the number of springs 313 that are disposed is three or more, because at least the bearing surface 2 can be supported as a plane. It is more preferable that the plurality of springs 313 is disposed at regular intervals in the circumferential direction of the rigid pole 311.

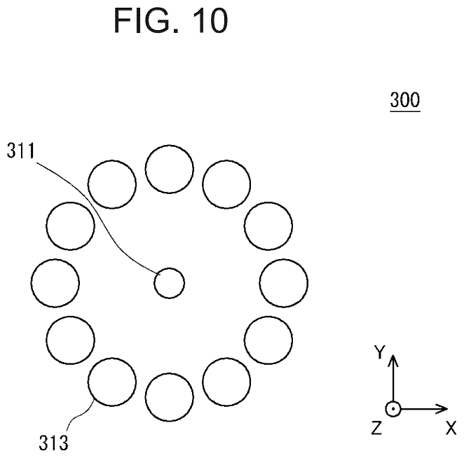

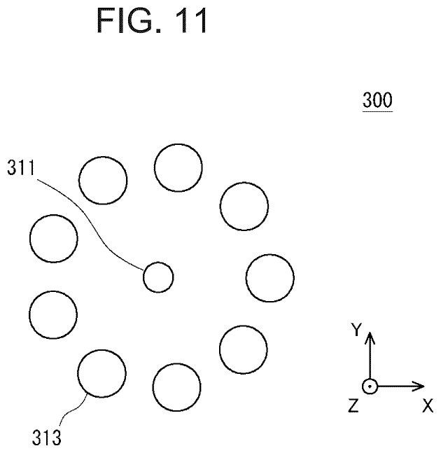

Each of FIG. 10 and FIG. 11 is a plan view showing an exemplary disposition of springs 313 of the chair 300 according to the third embodiment. For example, as shown in FIG. 10, a plurality of springs 313 is disposed so as to be symmetric about the axis of the rigid pole 311. However, in FIG. 10, the variation in the total of predetermined amounts of restoring forces that are generated from the plurality of springs 313 between a case where the bearing surface 2 is inclined in a direction in which the spring 313 exists and a case where the bearing surface 2 is inclined in a direction in which the spring 313 does not exist (that is, in a direction of a gap among the plurality of springs 313) can exceed the certain range. Therefore, in the case where a plurality of springs 313 is disposed so as to be symmetric about the axis of the rigid pole 311, it is preferable that a sufficiently large number of springs 313 is disposed such that the variation in the total of restoring forces is within the certain range. Further, as shown in FIG. 11, it is preferable that each of a plurality of springs 313 is disposed on the opposite side of a gap in a direction in which the spring 313 does not exist such that the springs 313 are not symmetric about the axis of the rigid pole 311.

The present disclosure is not limited to the above embodiments, and can be appropriately modified without departing from the spirit.

What is claimed is:

1. A chair comprising:
a base;
a bearing surface configured to incline a pelvis of a seated user;
a rigid pole including a lower end portion that is fixed to the base and an upper end portion that is fixed to the bearing surface such that the bearing surface is able to be inclined in all radial directions;
an elastic body disposed on a lower side of the bearing surface and configured to generate restoring force in all radial directions of the bearing surface depending on an inclination angle of the bearing surface;
an adjustment mechanism disposed between the elastic body and the base and configured to adjust a magnitude of the restoring force of the elastic body;
a rotation table installed on an upper side of the base and configured to rotate around a height-directional axis due to dynamic power;
a plurality of support poles installed on an upper side of the rotation table, configured to support the bearing surface at upper end portions of the support poles when the bearing surface is inclined, and including different height-directional lengths; and
a motor configured to generate the dynamic power.

2. The chair according to claim 1, wherein the elastic body is a spring made of metal.

3. The chair according to claim 1, wherein the elastic body is a tubular member composed of an elastomer.

4. The chair according to claim 1, wherein the elastic body is disposed between the bearing surface and the adjustment mechanism, so as to generate the restoring force in all radial directions of the bearing surface depending on the inclination angle of the bearing surface, such that a central axis of the elastic body coincides with a central axis of the rigid pole.

5. The chair according to claim 1, wherein the elastic body or a plurality of the elastic bodies is disposed in a circumferential direction of the rigid pole between the bearing surface and the adjustment mechanism, so as to generate the restoring force in all radial directions of the bearing surface depending on the inclination angle of the bearing surface.

6. The chair according to claim 1, wherein the adjustment mechanism is configured to adjust the magnitude of the restoring force of the elastic body, by moving a surface of the adjustment mechanism along the rigid pole, the surface of the adjustment mechanism abutting on the elastic body.

7. The chair according to claim 1, wherein:
the rigid pole includes a D-cut portion and a male thread portion disposed on a lower side of the D-cut portion;
the adjustment mechanism includes a support portion including a through-hole in which the D-cut portion is provided and a nut portion provided around the male thread portion by screwing;
the elastic body is disposed between the bearing surface and the support portion;
the support portion is attached to the rigid pole in a state where the D-cut portion is provided in the through-hole and where the support portion is able to move along the D-cut portion; and
the adjustment mechanism is configured to adjust the magnitude of the restoring force of the elastic body, by adjusting a screwing amount of the nut portion with respect to the male thread portion and moving the support portion along the D-cut portion.

8. The chair according to claim 1, further comprising a controller configured to increase or decrease a rotation speed of the motor.
